(19) United States
(12) Patent Application Publication
(10) Pub. No.: US 2002/0128853 A1
(43) Pub. Date: Sep. 12, 2002

(54) Electric appliance renting system

(76) Inventors: Hiroshige Kikuchi, Chiyoda (JP); Tadakatsu Nakajima, Chiyoda (JP); Keiji Sasao, Tsuchiura (JP); Chihiro Fukui, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/921,141

(22) Filed: Aug. 3, 2001

(30) Foreign Application Priority Data
Mar. 12, 2001 (JP) 2001-67950

(51) Int. Cl. G06F 17/60

(52) U.S. Cl. 705/1; 705/412

(57) ABSTRACT

In an electric appliance renting system, a use contractor leases an e-information terminal together with an e-air conditioner, an e-refrigerator and an e-television from a service providing company. The work information of these electric appliances is sent from the e-information terminal to a rent managing server, which the service providing company possesses, through the Internet. The rent managing server sends the data relating to the rent inclusive of the electric power rate of the rented electric appliances to the e-information terminal.

### BACKGROUND OF THE INVENTION

The present invention relates in general to an electric appliance renting system for renting electric appliances. More particularly, the invention relates to an electric appliance renting system for renting electric appliances inclusively of an electric power rate.

The fact is that almost all of the electric appliances, from the home electric appliances, are purchased to be used. When a purchaser uses any of the electric appliances, the electric power is supplied thereto from an electric power company with which the purchaser makes a contract. When an electric appliance develops trouble, if this trouble occurs within the guarantee period thereof, this electric appliance is repaired free of charge, which when an electric appliance develops trouble after a lapse of the guarantee period thereof, this electric appliance is repaired with an admission fee. Even when this electric appliance is scrapped, the scrapping may be expensive in many cases.

In a system for purchasing and using such electric appliances, the payment of the cash becomes maximum at the purchase time. For this reason, a great deal of money for payment needs to be prepared at the purchase time. In order to prevent a sum of money for the payment from becoming enormous at the purchase time, an electric appliance may be bought on the installment plan by utilizing the finance or the like of a financial company in some cases.

Now, it is as described above that the electric power which is used to operate an electric appliance is supplied from the electric power company with which the purchaser makes a contract. When collecting the electric power rate, a sum of the specific charge corresponding to an amount of consumed electric power measured by a watthour meter every home and the basic charge is charged for each of homes. In the case where each of home pays the charge, for the sake of convenience of the payment, in general, the bank automatic transfer is carried out. While the present condition is that for the measurement of an amount of consumed electric power, which each of homes has consumed, a measurement person goes round homes to carry out the measurement, there arises the inconvenience that the measurement is not efficiently carried out due to the installation positions of the watthour meters or watchdogs, and so forth. Then, in order to solve this inconvenience, it is described in JP-A-10-111326 that the data relating to an amount of electric power which is measured from the watthour meter is sent to the electric power company through the communication line.

In the above-mentioned conventional situation of utilizing electric appliances, if an electric appliance is purchased to be used, then the initial cost becomes enormous. Even if after the purchase of the electric appliance, the more excellent appliance is made public and then even if a purchaser desires the re-purchase, the purchase thereof becomes difficult in terms of funds. As a result, a purchaser must use a appliance having the large power consumption for a long term, and hence the inconvenience occurs in terms of the energy saving. In addition, in the case where a purchaser makes a finance contract with a financial company in order to reduce the initial cost, when viewed totally, the interest on money and the cost of the charge are excessively required. At this time, since the financial company changes the rate of the interest on money and the charge in correspondence to the bad debt risk, for each of general consumers, the ratio of the interest on money and the charge occupying the cost of the appliance becomes relatively large. In addition, in the case as well where a consumer leases an electric appliance from the present lease company, this is also applied thereto.

Now, when using an electric appliance, the total sum of the initial cost required in the purchase thereof, the running cost such as the electric power rate and the repair cost, and the scrapping cost required in the scrapping thereof is the cost required from the purchase of the electric appliance up to the scrapping thereof. It is desirable for users that the life cycle cost as this total sum is less. However, it is very difficult to estimate the life cycle cost and as a result, it is difficult for users or consumers to select the optimal appliance.

In the case where for example, an air conditioner for a home is purchased to be used, since the situation of the heat radiation and the installation situation of the heat source apparatus(es) in a room are difficult in accordance with a room where the air conditioner is installed, the heat balance is changed. In addition, the work pattern and the rate of operation are changed in accordance with the taste of a user. For this reason, the life cycle cost is changed every user, and also the optimal appliance which is fitted to a user is changed every user in terms of the life cycle cost.

Furthermore, the energy saving is desired in order to prevent the Earth warning. However, since the energy saving is also changed due to the performance of electric appliances, the use situation of a user, and the running pattern, it is difficult to select the appliance which is fitted to the taste of a user and promotes the energy saving. In addition, in the system, described in the above-mentioned official gazette, for checking an amount of consumed electric power in each of homes through the communication line, though the labor of checking an amount of consumed electric power in each of homes is surely reduced, the life cycle cost is not taken into consideration at all.

In this connection, when an electric appliance is intended to be scrapped since the use purpose has been attained, it is better in terms of the recycle possibility to return the electric appliance of interest to the source of the manufacturer. In this case, the recycle has the advantage that the Earth environment is protected and the low cost is realized. However, in the present distribution root of the electric appliances, such a measure is behind and hence it becomes the problem in the future to take such a measure.

### SUMMARY OF THE INVENTION

In the light of the foregoing, the present invention has been made in order to solve the above-mentioned problems associated with the prior art, and it is therefore an object of the present invention to construct an electric appliance renting system which is capable of reducing the life cycle cost.

It is another object of the present invention to reduce the initial investment of a user for an electric appliance.

It is still another object of the present invention to construct an electric appliance renting system which is capable of protecting the Earth environment.

It is yet another object of the present invention to construct an electric appliance renting system which is capable of making the man power saving possible.

Then, it is an object of the present invention to attain at least any one of these objects.

According to the first feature of the present invention for attaining the above-mentioned objects, there is provided an electric appliance renting system in which a use contractor who has made a contract with a service providing company leases an electric appliance rented out from the service providing company, wherein the electric appliance can send the data exhibiting the work situation thereof to a lease managing server, which the service providing company has, through a communication line, and also can receive the data relating to a rent inclusive of an amount of electric power thereof from the rent managing server.

According to the second feature of the present invention for attaining the above-mentioned objects, there is provided an electric power appliance renting system in which a user who has made a contract with a service providing company leases a plurality of electric appliances rented out from the service providing company, wherein at least one of the plurality of electric appliances can send data exhibiting the work situation of the plurality of electric appliances to a rent managing server, which the service providing company has, through the Internet, and also can receive rents, inclusive of an amount of electric power thereof, of the plurality of electric appliances from the rent managing server.

In addition, preferably, the plurality of electric appliances have at least one first electric appliance which is connected to the Internet, and a second electric appliance which is connected to the first electric appliance through a communication line.

According to the third feature of the present invention for attaining the above-mentioned objects, there is provided an electric appliance renting system in which a use contractor who has made a contract with a service providing company leases an electric appliance rented out from the service providing company, wherein the service providing company has a rent managing server for collecting the data relating to the work situation of the electric appliance rented out to a use contractor through a communication network to operate arithmetically a rent inclusive of an amount of electric power, which is to be paid by the use contractor, from the data relating to the work situation of the electric appliance thus collected, and the rent managing server can output the rent to the electric appliance through the communication network.

Then, in this feature, it is desirable that the rent managing server arithmetically operates the consumed electric power rate of the electric appliance thus rented out for an electric power supplying company for supplying the electric appliance thus rented out with the electric power, and can provide the electric power supplying company with the data relating to the consumed electric power rate through a communication network.

In addition, the service providing company may pay the consumed electric power rate of the electric appliance thus rented out which is arithmetically operated by the rent managing server to the electric power supplying company for supplying the electric appliance thus rented out with the electric power. In addition, the electric appliances thus rented out may have a first information electric appliance which is connected to the rent managing server of the service providing company through a communication network and a second information electric appliance which is connected to the first information electric appliance through a communication line. Furthermore, the first information electric appliance may display thereon the data relating to the work situation and the consumed electric power rates of the first and second information electric appliances. Also, the first information electric appliance may carry out the maintenance diagnosis or the replacement diagnosis of the information electric appliance which is connected to the first information electric appliance through the communication line.

According to the fourth feature of the present invention for attaining the above-mentioned objects, there is provided an electric appliance renting system for renting electric appliances, including: at least one electric appliance which is rented out, inclusively of the electric power rate, from a service providing company to a use contractor; and a rent managing server for managing the rented electric appliance(s) which the service providing company has, wherein the electric appliance has communication means for sending work result data to the rent managing server, and the rent managing server has communication means for receiving the work result data sent from the electric appliance.

Then, in the fourth feature, the rent managing server includes means for calculating a charge which is to be charged for a use contractor renting the electric appliance in accordance with the work result data and for calculating the electric power rate which is to be paid to an electric power supplying company in accordance with the work result data. The rent managing server records and manages thereat the work result data. The electric appliance renting system may further includes an information terminal through which the rent is carried out inclusively of the electric power rate, and the electric appliance, the information terminal and the rent managing server may have communication means for communicating with the information terminal, communication means for communicating with the electric appliance and the rent managing server, and communication means for communicating with the information terminal, respectively, and the information terminal may have means for recording the work result data, means for operating arithmetically an amount of consumed electric power from the work result data, and means for sending the data relating to an amount of consumed electric power thus arithmetically operated to the rent managing server.

Furthermore, the electric appliance may have operation controlling means for controlling the operation thereof, and the rent managing server may have means for obtaining an amount of consumed electric power of the electric appliance on the basis of the control data provided by the operation controlling means and for obtaining the use rate inclusive of an electric power rate which is to be charged for a use contractor and the electric power rate which is to be paid to the electric power supplying company.

In addition, in the above-mentioned fourth feature, electric power measuring means for measuring the electric power of the electric appliance is provided, and the rent managing server has means for operating arithmetically the use charge inclusive of an electric power rate which is to be charged for a use contractor and the electric power rate which is to be paid to the electric power company on the basis of an amount of electric power measured by the electric power measuring means. The rent managing server can send the data relating to the situation of the half-way progress of use of the electric power to the electric appliance. The rent managing server carries out the arithmetic operation in such a way that when the operation result data of the electric appliance is equal to or smaller than a predetermined amount, the consumed electric power rate is decided as the fixed amount, while when the operation result data of the electric appliance exceeds the predetermined amount, the consumed electric power rate is increased in accordance with the work result data. The rent managing server includes judgement means for on the basis of the work result data sent from the electric appliance, carrying out the judgement of abnormality of the electric appliance and for judging on the basis of the judgement result whether or not the maintenance needs to be carried out. The rent managing server may include means for generating a running pattern on the basis of the work result data sent from the electric appliance to compare the total cost up to the scrapping processing of the electric appliance with the total cost up to the scrapping processing of an electric appliance which is replaceable with the electric appliance to execute the replacement judgement for the electric appliance.

### BRIEF DESCRIPTION OF THE DRAWINGS

The above and other objects as well as advantages of the present invention will become clear by the following description of the preferred embodiments of the present invention with reference to the accompanying drawings, wherein:

FIG. 1 is a block diagram showing a configuration of a system of an embodiment of an electric appliance renting system according to the present invention;

FIG. 2 is a flow chart useful in explaining the operation of a system of an embodiment of an electric appliance renting system according to the present invention;

FIG. 3 is a detailed flow chart useful in explaining a part which is shown by the repetitive operation for a period of time of use contract in FIG. 2;

FIG. 4 is a block diagram showing a configuration of an embodiment of an information electric appliance according to the present invention;

FIG. 5 is a block diagram showing a configuration of an example of a change of the information electric appliance shown in FIG. 4;

FIG. 6 is a view useful in explaining one example of a screen which is displayed on an information terminal;

FIG. 7 is a graphical representation useful in explaining an example of a rental contract of an information electric appliance according to the present invention;

FIG. 8 is a graphical representation useful in explaining an example of a rental contract of an information electric appliance according to the present invention; and

FIG. 9 is a block diagram showing a configuration of a system of another embodiment of an electric appliance renting system according to the present invention.

### DETAILED DESCRIPTION OF THE EMBODIMENTS

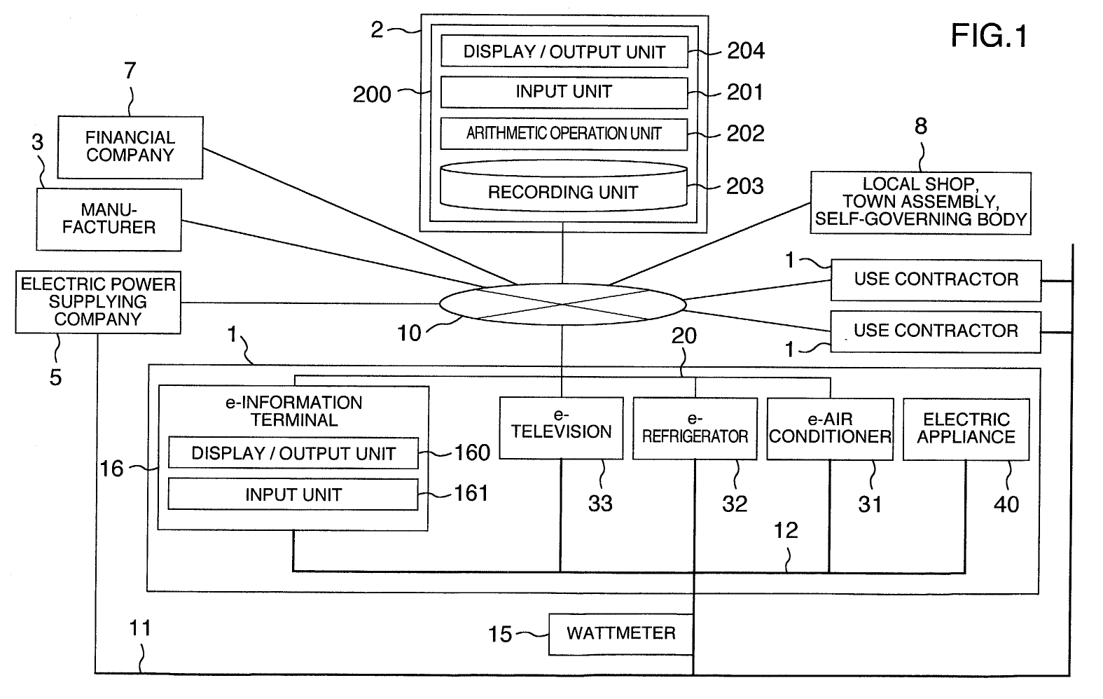

The preferred embodiments of the present invention will hereinafter be described in detail with reference to the accompanying drawings. FIG. 1 is a block diagram showing a configuration of a system of an embodiment of an electric appliance renting system according to the present invention. In the present embodiment, an electric appliance which can send/receive the information to/from the outside through the communication means such as the Internet will hereinbelow be referred to as “ an information electric appliance” for short, when applicable. Then, in order that a rented information electric appliance may be distinguished from an electric appliance which was purchased in the normal way, in the rented information electric appliance, “e-” is added to the head of a name of an electric appliance as in an e-air conditioner 31.

In FIG. 1, a use contractor 1 possesses the group of information electric appliances such as an e-air conditioner 31, an e-refrigerator 32, an e-television 33, and an e-information terminal 16 which were rented out on the basis of a use contract which will be described later, and an electric appliance 40 which is out of the use contract. Then, the group of information electric appliances 31 to 33 and the electric appliance 40 are detachably connected to an indoor power source line 12 through their plug sockets and plugs (not shown). The indoor power source line 12 is connected through a wattmeter 15 to a power-transmission line 11 for the electric power which is supplied from an electric power supplying company 5.

The e-information terminal 16 having an input unit 161 for inputting therethrough the information of the information electric appliances and a display output unit 160 for displaying thereon the data relating to the work situation and the like of the group of information electric appliances 31 to 33 is also connected to the indoor power source line 12 through a plug socket and a plug (not shown). The group of information electric appliances 31 to 33 is individually connected to or connected in series with the e-information terminal 16 through a communication line 20. The e-information terminal 16 collects the work information of the group of electric appliances 31 to 33 connected thereto. Then, the collected information itself of the group of electric appliances 31 to 33 or the information which is obtained by processing the collected information in the e-information terminal 16 is sent to a rent managing server 200, which a service providing company 2 possesses, through the Internet at all times.

The rent managing server 200 of the service providing company which is connected to the Internet 10 includes: a recording unit 203 for recording therein the information from a plurality of use contractors 1, 1, . . . which is sent thereto through the Internet 10; an input unit 201 for converting the information recorded in the recording unit 203 into the management data; an arithmetic operation unit 202 for converting the information into the management data; and a display/output unit 204 for displaying and outputting the input data and the management data.

The internet connection appliances such as the computers which an electric power supplying company 5 for supplying the group of information electric appliances 31 to 33 with the electric power, a manufacturer 3 which manufactured the group of information electric appliances 31 to 33, a financial company 7 which will be described later, a local self-governing body, a town assembly, and a local shop or store 8 to which a use contractor belongs possess respectively are connected to the Internet 10.

The collection of the electric appliance rental charge and the electric power rate in the present embodiment constructed as described above will hereinbelow be described. With respect to the group of electric appliances 31 to 33 and the e-information terminal 16, the rental or lease contract is made between a use contractor and the service providing company 2. The payment contract for the electric power rate is also contained in the rental or lease contract.

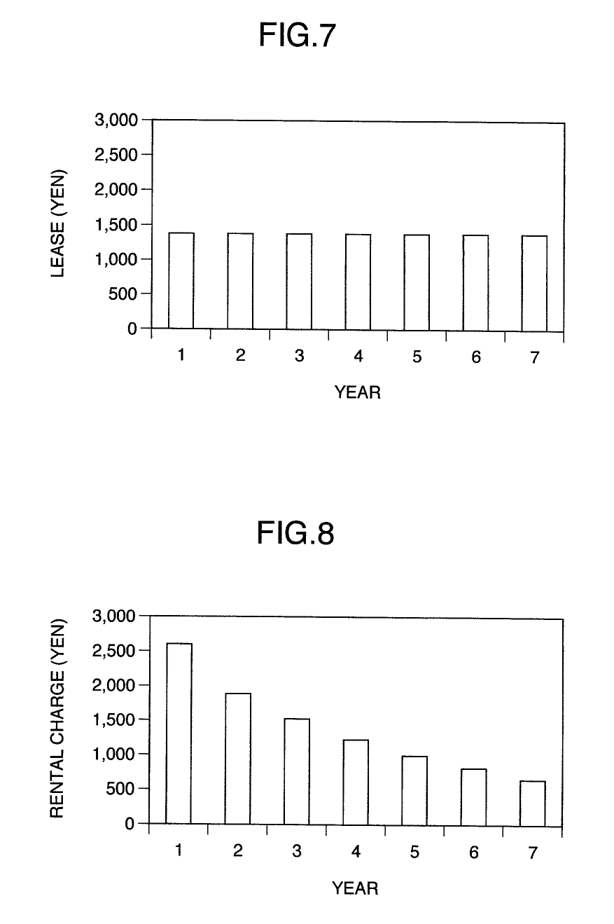

In other words, in the contract in which the use charge inclusive of the electric power rate for one month from the first day of the month to the end of the month for each of months is paid in the next month, if the rent of interest is the rent for a long term, then the lease charge for the group of electric appliances 31 to 33, as shown in FIG. 7, becomes the fixed amount for a period of time of the contract. In addition, in the case where the contract is cancelled in the middle of a period of time of the long term rent contract, the cancel charge is collected. In the case where an information electric appliance is rented out only for a short period of time, as shown in FIG. 8, the first year of the rental charge is highest and the rental charge is gradually decreased on and after the second year. The reason that in such a way, the payment pattern is changed between the case where an information electric appliance is rented out for a short period of time and the case where an information electric appliance is rented out for a long period of time is that the group of information electric appliances 31 to 33 are degraded due to the use thereof, and also the technology progresses due to a lapse of a time to reduce relatively the value of the appliances. On the other hand, if an amount of consumed electric power is equal to or smaller than amount of integrated electric power for each of months which was determined in the rental contract of an information electric appliance, then the consumed electric power rate is decided as the fixed amount. When an amount of consumed electric power exceeds an amount of integrated electric power which was determined in the rental contract of an information electric appliance, the specific charge which is obtained by multiplying an excess by a unit cost is added to be charged for a use contractor.

Once the rental or lease contract is established, the data relating to the work results of the e-air conditioner 31, the e-refrigerator 32 and the e-television 33 which use contractor 1, 1, . . . leases is sent from the e-information terminal 16 to the service providing company 2 through the Internet 10. On the other hand, the rent managing server 200 which the service providing company 2 possesses, on the basis of the data relating to the work results of the group of information electric appliances 31 to 33 sent from the use contractor 1, 1, . . ., arithmetically operates a charge demand amount for each of months based on the contract, or a cost amount on occasion to return the amount thus obtained to the e-information terminal 10 of the use contractor 1 through the Internet 10.

In this connection, the e-information terminal 16 is provided with input means 161 for being able to input therethrough the desires from the use contractor 1 such as the additional lease or replacement of the information electric appliances 31 to 33, or the additional rent of the different information electric appliance(s). In addition, the data relating to the trouble(s) generated in the group of electric appliances 31 to 33 which the use contractor 1 leased is also sent to the rent managing server 200 of the service providing company 2 through the e-information terminal 16.

Now, in order to calculate the rent inclusive of the electric power rate, which is to be charged for .the use contractors 1, 1, . . . , in accordance with the work results thereof, the service providing company 2, on the basis of the above-mentioned method, obtains the electric power rate of all of the information electric appliances, which are rented out to the use contractors 1, 1, . . ., using the rent managing server 200 and adds up the electric power rate together with the rent to charge the rents thus obtained for the users 1, 1, . . . , respectively. At the same time, the service providing company 2 calculates the consumed electric power rate, which is to be paid to the electric power supplying company 5 using the rent managing server 200 thereof in accordance with the work result data of the group of information electric appliances. In this connection, the rent managing server 200 sums up the consumed electric power rate of all of the information electric appliances such as the e-air conditioner 31, the e-refrigerator 32, the e-television 33 and the e-information terminal 16 which are rented out inclusively of the electric power rate.

Since the use contractor 1, 1, . . . uses his/her own electric appliance 40 in addition to the group of electric appliances 31 to 33 for which the rent contract was made with the service providing company 2, it is difficult to distinguish between the electric power rate for the rent and the electric power rate for his/her payment amount only on the basis of the information from the wattmeter 15. Then, an amount of consumed electric power of his/her own electric appliance 40 is obtained as follows.

That is, the total amount of consumed electric power of the e-information terminal 16, the e-air conditioner 31, the e-refrigerator 32, the e-television 33 and other electric appliance 40 which are all connected to the indoor power source line 12 is measured by the wattmeter 15. On the other hand, since the work result data is sent from the e-information terminal 16, the e-air conditioner 31, the e-refrigerator 32 and the e-television 33 either to the e-information terminal 16 or to the rent managing server 200 of the service providing company, either the e-information terminal 16 or the rent managing server 200 of the service providing company calculates an amount of consumed electric power of the e-information terminal 16, the e-air conditioner 31, the e-refrigerator 32 and the e-television 33 on the basis of the work result data sent thereto. Then, an amount of electric power thus calculated is subtracted from an amount of electric power which is previously measured by the wattmeter 15. Then, the use contractor 1 who made the rental contract with the service providing company 2 pays the use charge inclusive of the electric power rate of the e-information terminal 16 and the group of information electric appliances 31 to 33 to the service providing company 2. On the other hand, the use contractor 1 pays the electric power rate of his/her own electric appliance 40 to the electric power supplying company 5.

Since the service providing company 2 makes the rental contract with a large number of use contractors 1, 1, . . . , an amount of consumed electric power also becomes enormous. For this reason, the service providing company can make a large contract with the electric power supplying company 5, i.e., can make the contract therewith for which the discount is made as compared with each of the electric power contracts which individual use contractors make with the electric power supplying company. By the way, the service providing company 2 pays the sum of the consumed electric power rate of all of the group of electric appliances (the e-information terminal 16, the e-air conditioner 31, the e-refrigerator 32 and the e-television 33) and the use charge of the power-transmission line 11 to the electric power supplying company.

Now, the rent managing server 20 of the service providing company 2 is also adapted to manage the inter-electronic commercial transaction of the manufacturer 3, the electric power supplying company 5, the financial company 7, and the local shop or store, the town assembly and the self-governing body 8. Now, by the transaction with the local shop or store, the town assembly and the self-governing body 8 is meant the advertisement income which is obtained in such a way that the local shop or store, the town assembly and the self-governing body 8 transmits distributively the advertisement of its products to the rented e-information terminal 16. By including the advertisement income, it is possible to reduce the use charge inclusive of the electric charge rate.

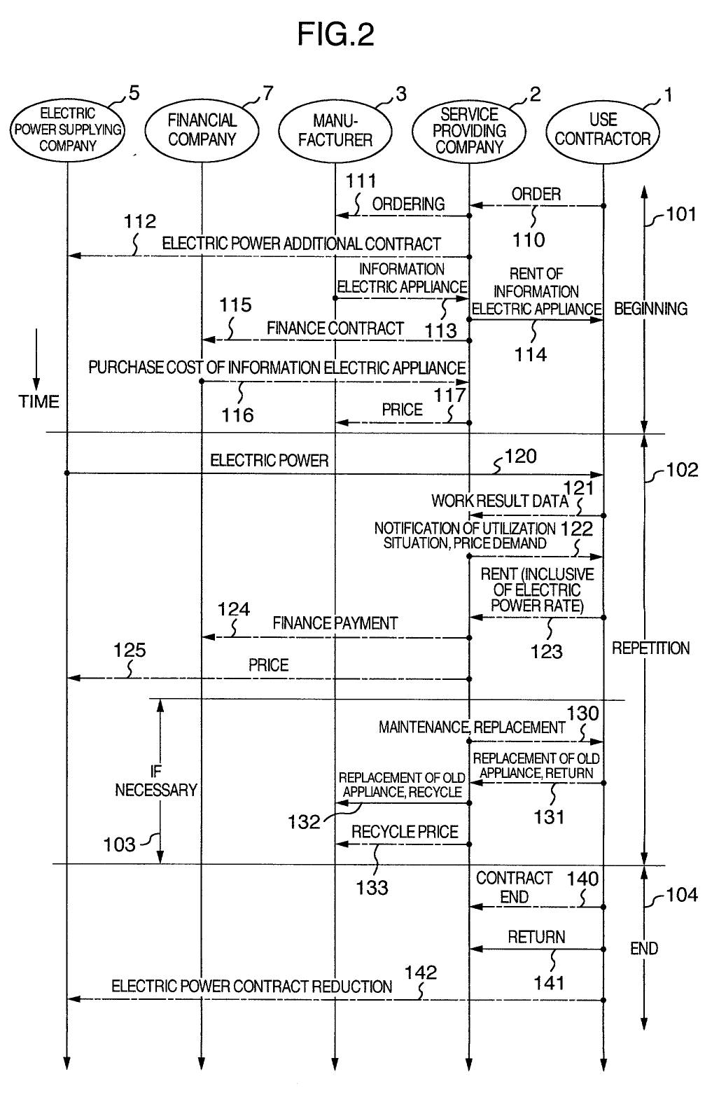

The description will hereinbelow be given with respect to the operation of starting the contract, the normal flow and the operation of ending the contract with reference to FIG. 2. Arrows 110, 111, 112, . . . of dashed lines indicate the flow of the information and the memory, while arrows 114, 120, . . . of solid lines indicate the flow of the goods, the work and the electric power. In principle, the memory is paid on the basis of the financial transaction through the Internet.

The description will hereinbelow be given with respect to the operation when starting the use contract or when starting the additional use contract. A part indicated in the right end of FIG. 2 by BEGINNING 101 corresponds to this operation.

An order that the use contractor 1 wants to take the rent service inclusive of the electric power rate of an information electric appliance is given from the use contractor 1 to the service providing company 2 (Step 110). Then, the service providing company 2 gives the manufacturer 3 an order for the information electric appliance (Step 111). At the same time, the service providing company 2 makes an additional contract with the electric power supplying company 5 with respect to the use of the electric power of the ordered information electric appliance (Step 112). Then, the manufacturer 3 sells the ordered information electric appliance to the service providing company 2 (Step 113). The service providing company 2 sends the purchased information electric appliance to the use contractor 1 (Step 114). At the same time, the service providing company 2 makes a finance contract with the financial company 7 (Step 115). Then, the service providing company 2 which has been furnished with funds from the financial company 7 on the basis of the finance contract pays the price for the information electric appliance to the manufacturer 7 (Step 116).

Next, the description will hereinbelow be given with respect to the operation for a period of time of the normal contract. This operation corresponds to the operation in repetition 102 part shown in the right end of FIG. 2. For a period of time of the contract, this operation is repeatedly carried out. In this repetitive operation 102, a part indicated by “IF NECESSARY” 103 is executed only when as a result of carrying out the maintenance diagnosis and the replacement diagnosis using the software of the expert system in the rent managing server 200 on the basis of the work result data, this process is judged to be necessary.

The information electric appliance which has been rented out to the use contractor 1 is supplied with the the electric power from the electric power supplying company at all times (Step 120). The work result data such as an amount of consumed electric power is sent to the rent managing server 200 of the service providing company 2 through the Internet 10 (Step 121). The rent managing server 200 of the service providing company 2 receives and records the work result data such as an amount of consumed electric power which has been sent from the rented information electric appliance. Then, the rent managing server 200 sums up an amount of consumed electric power every month to notify the use contractor 1 of the use situation and to charge the use charge inclusive of the electric power rate for the use contractor 1 (Step 122). Then, the use contractor 1 pays the use charge inclusive of the electric power rate which has been charged therefor (Step 123).

The service providing company 2 repays the contracted finance to the financial company 7 every term which was determined on the basis of the contract made with the financial company 7 (Step 124). Then, the service providing company 2 sums up an amount of consumed electric power of all of the rented information electric appliances to pay the electric power rate to the electric power supplying company 5 every term which was determined on the basis of the contract made with the electric power supplying company 5 (Step 125).

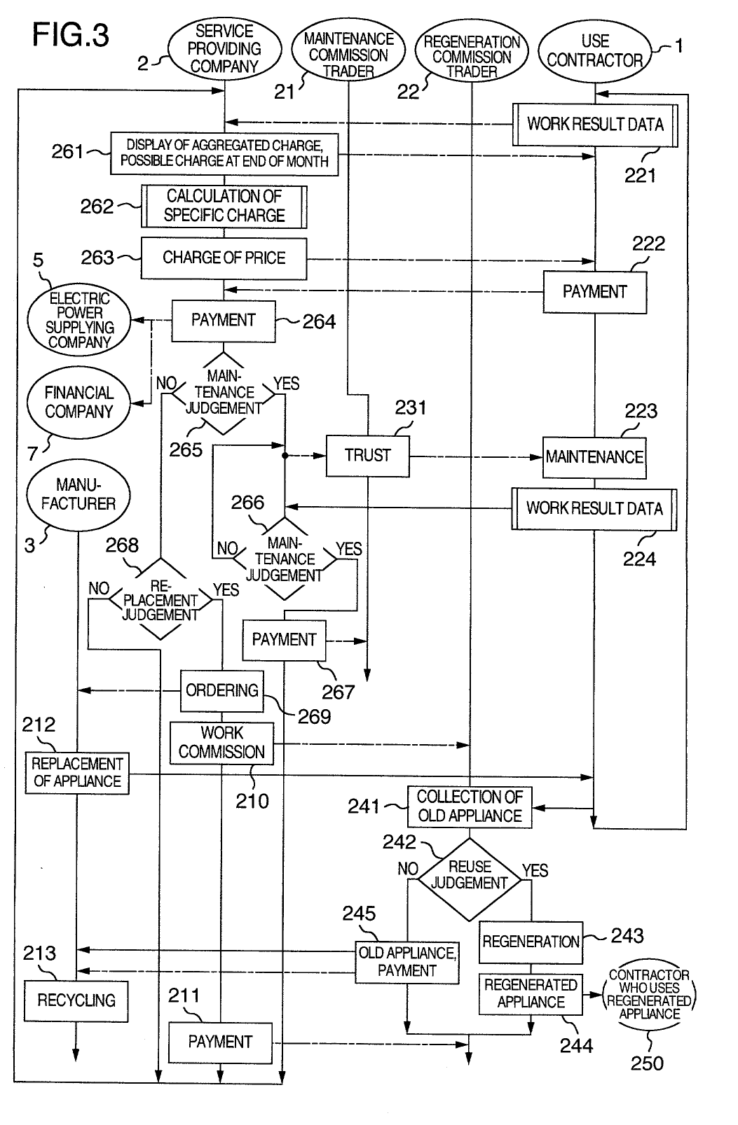

Next, the description will hereinbelow be given with respect to the outline of the maintenance and replacement operation in the part indicated by “IF NECESSARY” 103. The details will be described later with reference to FIG. 3.

The rent managing server 200 of the service providing company 2 carries out the maintenance diagnosis and the replacement diagnosis on the basis of the result data of the consumed electric power and the measured information from the various kinds of sensors mounted to the information electric appliances. If the degree of such information exceeds the critical value which is previously stored in the rent managing server 200, then the rent managing server 200 judges that the maintenance or the replacement is necessary to instruct the service providing company to carry out the maintenance or the replacement. Then, the service providing company 2 carries out the maintenance work or the replacement work in accordance with the instruction for the maintenance or the replacement issued from the rent managing server 200 (Step 130).

The case where the use contract is ended or the case of the end of the partial use contract in which a part of the use contract of the information electric appliance 15 for which the use contract is made with the service providing company will hereinbelow be described with reference to the part indicated by “BEGINNING” in the right end of FIG. 2. The service providing company is informed of the end of the use contract or the end of a part of the use contract from the use contractor (Step 140). After having carried out this communication, the service providing company collects the information electric appliance for which the use contract has been ended (Step 141). Then, the service providing company notifies the electric power supplying company of that the use contractor changes the current contract over to the new contract in which the electric power contract amount is reduced by an amount of electric power with which the current contract has been made with the service providing company for the information electric appliance for which the use contractor has ended the use contract (Step 142).

Next, the details of the repetitive operation for a period of time of the use contract shown in FIG. 2 will hereinbelow be described with reference to a flow chart of FIG. 3. The work result data such as an amount of consumed electric power of the information electric appliance rented out to the use contractor 1 is sent to the rent managing server 200 included in the service providing company 2 (Step 221). The rent managing server 200 of the service providing company 2 aggregates an amount of consumed electric power from the first day of the month on the basis of the work result data set thereto and calculates an amount of consumed electric power until the time point of interest and an amount of possible consumed electric power up to the end of the month to send the resultant data to the e-information terminal 16 of the use contract 1 (Step 221). The data sending in Steps 220 and 221 is carried out at predetermined time intervals, or when a request is made from the rent managing server 200 of the service providing company through the Internet 10, or when a request is made from the e-information terminal 16 of the use contractor 1 through the Internet 10.

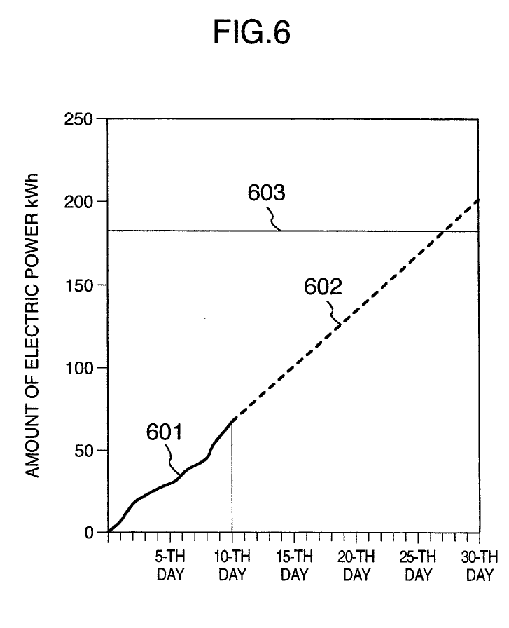

FIG. 6 shows one example of the relationship between an amount of consumed electric power the data of which is sent from the service providing company and an amount of possible consumed electric power up to the end of the month. Such information is displayed on the e-information terminal 16 (Step 261 in FIG. 3). A part of a solid line 601 indicates an amount of consumed electric power which has been actually consumed from the first day of the month, and a part of a dotted line 602 indicates an amount of possible consumed electric power. A solid line 603 indicates the upper limit value of an amount of electric power which can be consumed with the fixed amount charge. Then, if an amount of actually consumed electric power exceeds this upper limit value, then the specific charge is added for an amount of exceed electric power. The use contractor 1 can confirm the situation of an amount of consumed electric power in real time from the screen of the e-information terminal 16. As a result, the use contractor 1 can finely manage an amount of consumed electric power and hence can grasp the over-consumption of the electric power, and the like.

The rent managing server 200 of the service providing company 2 sums up an amount of consumed electric power of the last month in the first day of the month to charge the use charge inclusive of the electric power rate for the last month for the use contractor (Step 263). The service providing company 2 pays the electric power rate to the electric power supplying company 5 every term which was determined in the contract and also repays the finance to the financial company 7 (Step 264).

The rent managing server 200 of the service providing company 2 checks periodically the work result data to judge whether or not it is necessary to carry out the maintenance of the information electric appliance (Step 265). If it is judged in Step 265 that it is necessary to carry out the maintenance of the information electric appliance (Step 265), then the service providing company 2 commissions a maintenance commission trader 21 to carry out the maintenance work (Step 231). The maintenance commission trader 21 subjects the information electric appliance for which the maintenance is required to the maintenance (Step 223). Then, after completion of the maintenance, the rent managing server 200 of the service providing company 2, on the basis of the work result data (Step 224) sent from the information electric appliance for which the maintenance has been carried out, judges whether or not it is necessary to carry out further maintenance (Step 266). If it is judged in Step 265 that it is necessary to carry out further maintenance again (YES in Step 266), then the service providing company 2 commissions the maintenance commission trader 21 to carry out the maintenance work once again. If in the maintenance judgement at the second time, it is judged that it is unnecessary to carry out the maintenance since the information electric appliance operates normally (NO in Step 266), then the charge is paid to the maintenance commission trader 21 (Step 267).

In addition, if it is judged that it is necessary to carry out the maintenance since the information electric appliance operates normally in Step 265 (NO in Step 265), then it is judged whether or not it is necessary to carry out the replacement (Step 268). In this judgement, the case where the present appliance is used and the case where a new appliance is used which is newly put on the market after the rent are compared with each other. In other words, on the basis of the work result data of the information electric appliances which has been accumulated, the use charge inclusive of the electric power rate when the information electric appliance is used which is newly put on the market and the sum of the total cost until now of the rented information electric appliance and the cost which is estimated to be generated in the future are compared with each other. If by taking the function(s) as well added to the new appliance into consideration, the service providing company judges that there is the merit in terms of the charge and the function for a customer, then the service providing company proposes the replacement of the information electric appliance for the customer. Then, when the customer consents to that proposal, YES is selected in the replacement judgement 268, while in other cases, NO is selected in the replacement judgement 268.

When YES is selected in the replacement judgement 268, the service providing company 2 orders a new information electric appliance from the manufacturer 3 (Step 209). At the same time, the manufacturer 3 requests a regeneration commission trader 22 to send the ordered information electric appliance. The service providing company 2 commissions the regeneration commission trader 22 to carry out the work of replacing the old information electric appliance with the new information electric appliance and the management of the old information electric appliance (Step 210). After having received the new information electric appliance from the manufacturer 3, the regeneration commission trader 22 carries the new information electric appliance to the use contractor 1 to replace the old information electric appliance with the new information electric appliance to collect the old information electric appliance (Step 241). Then, the regeneration commission trader 20 judges whether or not the collected information electric appliance is regeneratable (Step 242).

If it is judged in Step 243 that the collected information electric appliance is regeneratable (YES is selected in Step 242), then the collected old information electric appliance is regenerated (Step 243). The information electric appliance thus regenerated is rented out to the contractor 250 who uses the regenerated appliance at the low priced charge. When the contractor 250 who uses the regenerated appliance can not be found out, the regenerated information electric appliance is damped to be sold or stocked as the appliance for the maintenance.

On the other hand, if it is judged in Step 242 that the regeneration is impossible (NO is selected in Step 242), then the collected information electric appliance is delivered together with the recycling price to the manufacturer 3 which manufactured the information electric appliance of interest to request the manufacturer 3 to recycle a part of the appliance which can be used again after the recycling and to scrap a part thereof which can not be recycled by any means (Step 245). The manufacturer 3, on the basis of this request, recycles a part of the appliance which can be used again after the recycling and scraps a part of the appliance which can not be recycled by any means (Step 213). Then, the service providing company 2 pays the price for the replacement commission work to the regeneration commission trader 22.

By the way, while the destination of the deliver of the old information electric appliance which was collected in the replacement is decided as the manufacturer 3 which manufactured the information electric appliance, alternatively, the destination of the deliver may be a waste treatment trader. In addition, while the trader for regenerating the information electric appliance is decided as the regeneration commission trader, alternatively, it may be a company or a manufacturer different from the replacement trader. In any case, it is desirable that the trader of interest is the trader which reutilizes a part of the appliance which can be reused. Since in the scrapping, the information of the work result is left, it is possible to estimate the degradation state of the information electric appliance, and hence the reutilization of components and parts can be judged and at the same time the quality improvement in the recycle materials can be realized.

Since the work result data of the rented information electric appliances is accumulated in the rent managing server 200, the service providing company 2 can carry out the replacement proposal in which the operation pattern, the operation rate and the like of the use contractor 1 are taken into consideration. Since for the use contractor 1, the replacement is proposed at the suitable time, the total cost can be reduced.

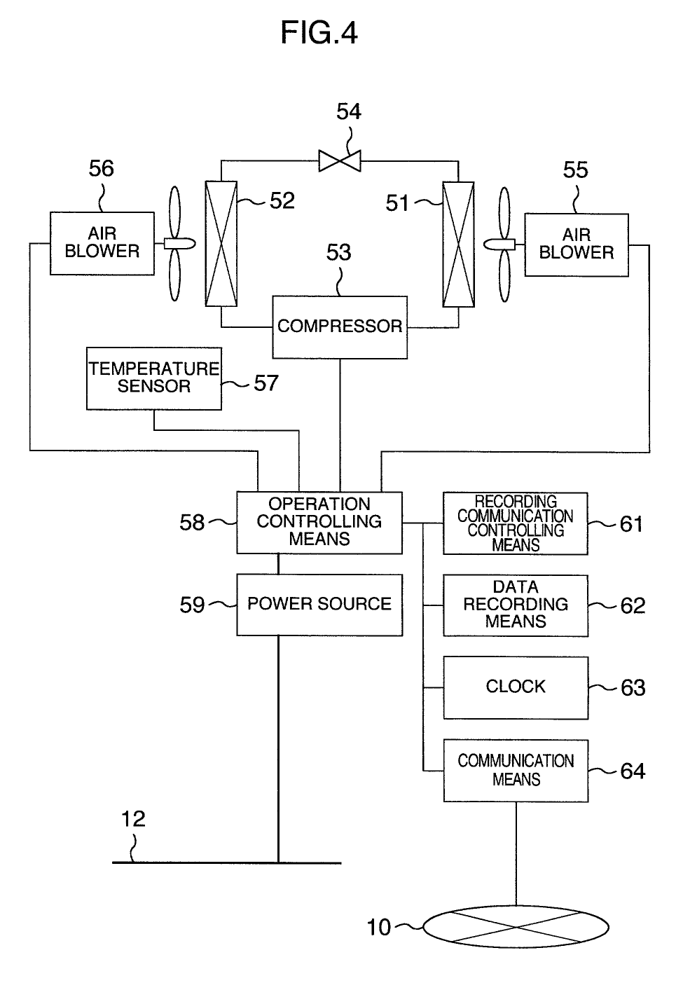

The description will hereinbelow be given with respect to the case where the information electric appliance is an e-air conditioner with reference to FIG. 4. The e-air conditioner includes a compressor 53 for compressing the cooling medium, an outdoor hear exchanger 51 for carrying out the heat exchange between the cooling medium and the outdoor air, an outdoor air blower 55 for sending the cooled wind to the outdoor heat exchanger 51, an expansion valve 54 which is adapted to operate by the adiabatic expansion of the cooling medium, and an indoor heat exchanger 52 for carrying out the heat exchange between the cooling medium and the indoor air. In addition, the e-air conditioner also includes an air blower 56 for sending air to the indoor heat exchanger to send the air-conditioned wind to a room, a temperature sensor 57 for measuring the temperature in a room, and a power source 59 connected to an indoor electric power line. A signal sent from the temperature sensor 57 is taken in the operation controlling means, and on the basis of this signal, the operations of the compressor 53, the outdoor air blower 55 and the outdoor air blower 56 are controlled. The work result data of the e-air conditioner is recorded in data recording means 62. The timing and the like of this recording are controlled by recording communication controlling means 61. By the way, the recording time and the like are recorded at a time when a clock 63 generates the clock data. The work result data thus recorded is sent to the rent managing server of the service providing company via communication means connected to the Internet.

More specifically, if the operation controlling means 58 operates/stops the e-air conditioner, the recording communication controlling means 61 aggregates an amount of electric power in the ON state to calculate an amount of consumed electric power and then the data recording means 62 records the work result data together with a time the data of which has been outputted from the clock 63. The data such as the indoor temperature and the indoor setting temperature which the temperature sensor 57 has measured is also recorded as one of the work result data together with a time the data of which has been outputted from the clock 63 in the data recording means 62. The temperature measurement data is also treated as the work result data, whereby the maintenance diagnosis and the replacement diagnosis can be carried out with higher accuracy, and also the labor costs of the maintenance can be reduced. In addition, the life sensor, the acoustic sensor and the like which are dedicated to the maintenance diagnosis and the replacement diagnosis may be provided to add the measurement result of the sensors to the work result data. If such dedicated sensors are provided, then the life judgement can be carried out with higher accuracy.

The communication means 64 sends the recorded work result data to the rent managing server 200 at predetermined time intervals or when a request has been made from the rent managing server 200. The rent managing server 200 calculates the electric power rate which is to be charged for the use contractor 1 and the electric power which is to be paid to the electric power company 5 in accordance with the data relating to an amount of consumed electric power sent thereto.

In the maintenance diagnosis in which the rent managing server 200 carries out the simulation by utilizing the work result data, the data of the simulation result and the data of the work result are compared with each other, and whether or not there is the abnormal data is judged by using the software included in the maintenance expert system. The maintenance expert system is programmed in the format of IF˜, THEB˜. This maintenance expert system compares the data of the simulation result and the data of the work result with each other, and when there is the abnormal data, instructs the failure contents and the maintenance corresponding thereto. According to the present system. the maintenance diagnosis can be carried out from a distance, the appliance does not need to be looked at on the site, and hence it is possible to reduce the labor costs and the maintenance time which are required for the maintenance.

In the replacement diagnosis of diagnosing the replacement time of the information electric appliance on the basis of the running pattern generated from the work result data, the work situation of a new appliance and the appliance which is currently rented out is simulated by the rent managing server 200 to carry out the comparison with respect to the use charge inclusive of the electric power rate and the necessary energy. Further, the comparison is carried out with respect to the new function(s) added to the new appliance, and by using the replacement expert system, the intelligible proposal contents in which the comparison with respect to the use charge inclusive of the electric power rate, the energy and the additional function(s) is described is generated for the use contractor 1. Then, the proposal contents are sent to the e-information terminal to display thereon the replacement contents for the use contractor 1. Thereby, the suitable replacement proposal can be carried out every use contractor.

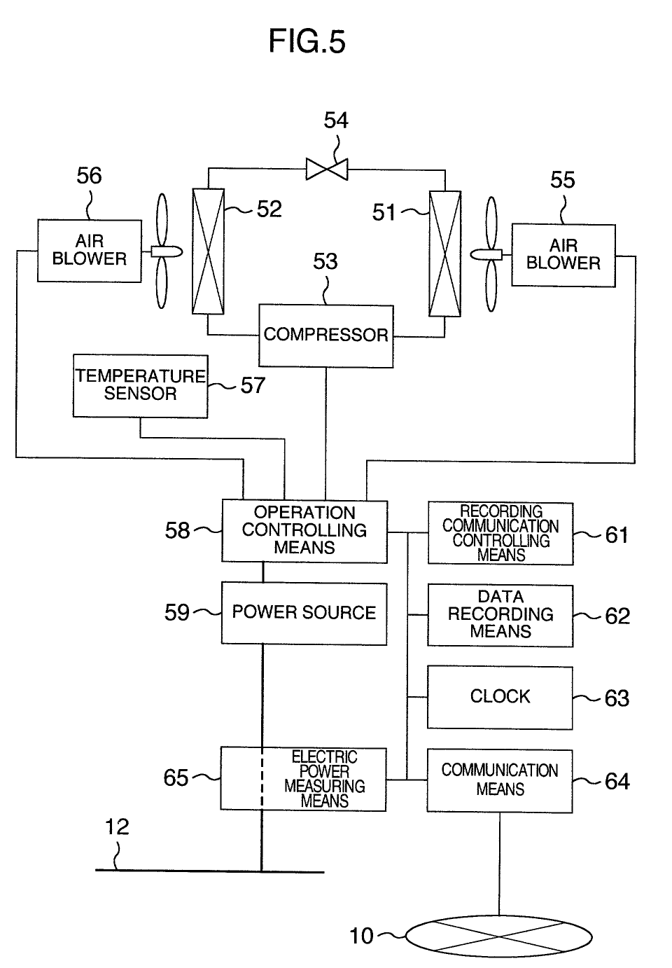

An example of a change of the air-conditioner is shown in FIG. 5. A point of difference of the present change from the embodiment shown in FIG. 4 is that the e-air conditioner includes electric power measuring means 65. The electric power which is measured by the electric power measuring means 65 is aggregated to obtain an amount of consumed electric power which is in turn stored together with the time data generated from the clock 63 in the form of the work result data in the data storage means. The present change is suitable when the data of an amount of consumed electric power can not be obtained from the operation controlling means 58.

According to the above-mentioned embodiments and change, since the service providing company 2 can carry out the large transaction to the manufacturer 3, the electric power supplying company 5, and the financial company 7, the service providing company 2 can carry out the transaction under the more advantageous condition in terms of the cost than any of general consumers who carries out a small transaction. In addition, since the information of the rented electric appliances can be obtained every moment through the Internet, it is possible to reduce the labor costs for the management and the administration of the service with which the electric appliances are rented inclusively of the electric charge rate.

In addition, according to the present embodiment, since any of the use contractors can lease the electric appliances on the basis of the rent contract, the use contractor does not need to prepare the initial investment as the large cost required to purchase the electric appliance(s). In addition, since the use contractor is informed of the detailed use charge inclusive of the electric power rate every month or periodically every information electric appliance, it is possible to clarify the expenses for a long term and hence it is possible to estimate the budget of the expenses. Furthermore, since the cost required up to the life of the information electric appliance which the use contractor uses becomes the value which is obtained by aggregating the use charge inclusive of the monthly electric power rate of the rented information electric appliance by the number of months for use, it is possible to grasp readily the total cost up to the life.

Further, since the work result data can be collected from an out-of-the-way place and also the maintenance diagnosis can be carried out from an out-of-the-way place, it is possible to reduce the labor costs and a time which are required for the maintenance. In addition, since the use contractor can get the service providing company to cope immediately with the maintenance at a time when the maintenance needs to be carried out, the stop of use of the information electric appliance due to the failure can be prevented.

An example of a change of the present invention will hereinbelow be described. The present change is the case corresponding to the example shown in FIG. 4 in which the operation controlling means 58 for controlling the work of the individual information electric appliances can not obtain the electric power consumption information. Since the consumed electric power data can not be obtained, the ON time, the temperature of the information electric appliance, and the like are measured, and the electric power values of the individual information electric appliances are estimated on the basis of the simulation. The estimated electric power values are aggregated to obtain the predicted value of an amount of consumed electric power. On the basis of the predicted value of an amount of consumed electric power, the electric power rate which is to be charged for the use contractor 1, and the electric power rate which is to be paid to the electric power supplying company 5 are respectively calculated. While since an amount of consumed electric power is the predicted value, there is the possibility that the error may be generated, the unit price of the electric power rate which is to be paid to the electric power supplying company 5 is increased to absorb that error. According to the present change, it is unnecessary to provide the electric power measuring means in the individual information electric appliances, and hence it is possible to reduce the cost of the system.

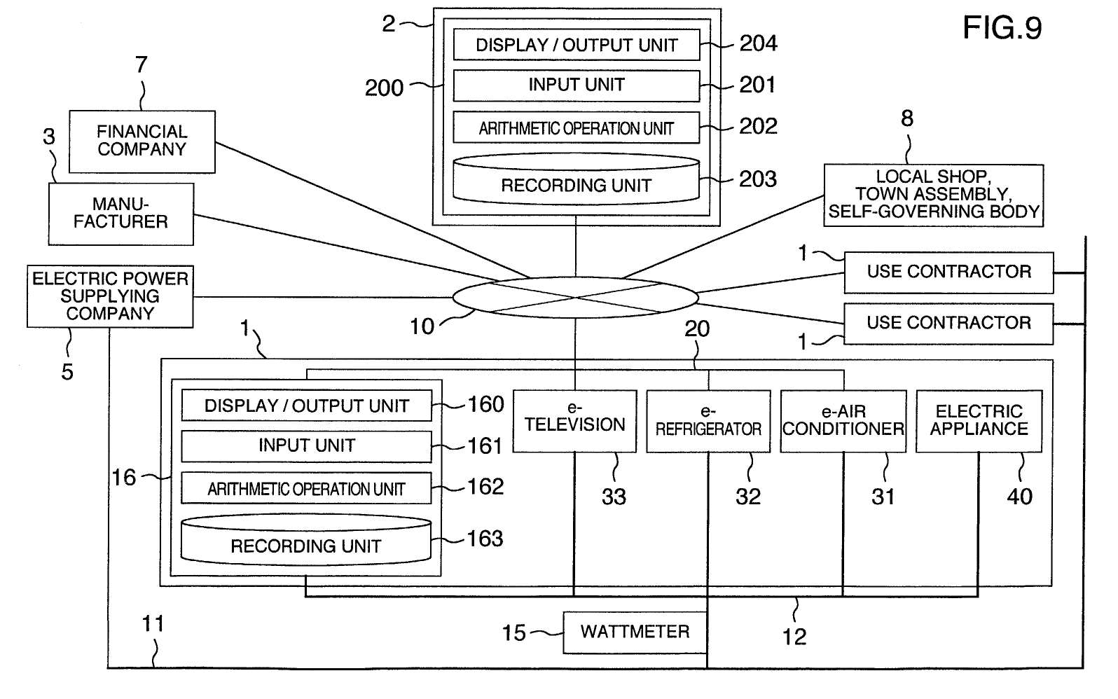

Another embodiment of the present invention is shown in FIG. 9. A point of difference of the present embodiment from the embodiment shown in FIG. 1 is that the e-information terminal 16 includes an arithmetic operation unit 162 and a recording unit 163 in addition to the display/output unit 160 and the input unit 161. As a result, in the embodiment shown in FIG. 9, the e-information terminal 16 is adapted to carry out a part of the functions which the rent managing server 200 of the service providing company 2 carried out in the embodiment of FIG. 1. More specifically, the e-information terminal 16 records the work result data of the e-information terminal 16 itself, the e-air conditioner 31, the e-refrigerator 32 and the e-television 33 in the recording unit 163. Then, an amount of consumed electric power is summed up by the arithmetic operation unit 162, and the use charge inclusive of the electric power rate of the use contractor 1 is summed up and the maintenance diagnosis and the replacement diagnosis are carried out. The data relating to an amount of consumed electric power and the use charge inclusive of the electric power rate which have been respectively summed up, and the maintenance diagnosis result and the replacement diagnosis result which have been respectively carried out are sent to the rent managing server 20 of the service providing company 2 through the Internet.

According to the present embodiment, an amount of communication and the number of times of communications through the Internet can be reduced as compared with the embodiment shown in FIG. 1. In addition, since an amount of communication data of one time can be reduced, it is also possible to increase the frequency in diagnosis, and the frequency in data collection of each of the information electric appliances.

By the way, while in any of the above-mentioned embodiments and change, the data relating to the work situation of the information electric appliances 31 to 33 is sent to the rent managing server 200 of the service providing company through the e-information terminal 16, it is to be understood that each of the information electric appliances 31 to 33 may have the sending function and the display function. In this case, there is offered the advantage that the e-information terminal becomes unnecessary, and the necessity and the like of the maintenance of the individual information electric appliances can be readily grasped.

In addition, while the communication line from the information electric appliances to the rent managing server of the service providing company is constructed by the Internet, it may also be other communication line such as the telephone line or CATV. In this case, there is offered the advantage that the collection of the information and the display thereof can be readily carried out using the existing equipment.

Also, while in the above-mentioned embodiments, the use charge of the power-transmission line is paid from the electric power supplying company to the power-transmission line possessing company, it is to be understood that the service providing company may directly pay the use charge of the power-transmission line to the power-transmission line possessing company. Further, while the number of electric power supplying companies with which the service providing company makes a contract is decided as one, a plurality of electric power supplying companies may be selected in accordance with the situation of supplying the electric power. As a matter of course, the electric power supplying company for supplying the information electric appliances with the electric power may be different from the electric power supplying company for supplying the general dielectric appliances which a user purchased with the electric power. As a result, while in Japan where the electric power supply is being liberalized, the electric power company for supplying the electric power is basically determined every area, it is possible that only the information electric appliances are supplied with the electric power from the electric power supplying company which is newly joined therein, and hence the market for the electric power companies which are newly joined therein is extended. In addition, while in the above-mentioned embodiments, using jointly or the like of the specific system is determined in the contract, of course, the charge contract is not limited thereto and hence may be variously changed in accordance with the situation.

As set forth hereinabove, according to the present invention, since it is possible to construct a system for renting electric appliances, the initial investment of a user for electric appliance(s) can be reduced. In addition, since the recycle system can be established on the basis of the rent, it is possible to obtain an electric appliance renting system which is adapted to protect the Earth environment. Also, it is possible to realize the man power saving of the staff required for the maintenance and the like.

While the present invention has been particularly shown and described with reference to the preferred embodiments and the specified change and modifications thereof, it will be understood that the various changes and other modifications will occur to those skilled in the art without departing from the scope and true spirit of the invention. The scope of the invention is therefore to be determined solely by the appended claims.

What is claimed is:

1. An electric appliance renting system in which a use contractor who has made a contract with a service providing company leases an electric appliance rented out from said service providing company,
wherein said electric appliance can send the data exhibiting the work situation thereof to a rent managing server, which said service providing company has, through a communication line, and also can receive the data relating to a rent inclusive of an amount of electric power thereof from said rent managing server.

2. An electric appliance renting system in which a user who has made a contract with a service providing company leases a plurality of electric appliances rented out from said service providing company,
wherein at least one of said plurality of electric appliances can send data exhibiting the work situation of said plurality of electric appliances to a rent managing server, which said service providing company has, through the Internet, and also can receive rents, inclusive of an amount of electric power thereof, of said plurality of electric appliances from said rent managing server.

3. An electric appliance renting system according to claim 2, wherein said plurality of electric appliances have at least one first electric appliance which is connected to the Internet, and a second electric appliance which is connected to said first electric appliance through a communication line.

4. An electric appliance renting system in which a use contractor who has made a contract with a service providing company leases an electric appliance rented out from said service providing company,
wherein said service providing company has a rent managing server for collecting the data relating to the work situation of said electric appliance rented out to a use contractor through a communication network to operate arithmetically a rent inclusive of an amount of electric power, which is to be paid by the use contractor, from the data relating to the work situation of said electric appliance thus collected, and said rent managing server can output the rent to said electric appliance through said communication network.

5. An electric appliance renting system according to claim 4, wherein said rent managing server arithmetically operates the consumed electric power rate of said electric appliance thus rented out for an electric power supplying company for supplying said electric appliance thus rented out with the electric power, and can provide said electric power supplying company with the data relating to the consumed electric power rate through a communication network.

6. An electric appliance renting system according to claim 4, wherein said service providing company pays the consumed electric power rate of said electric appliance thus rented out which is arithmetically operated by said rent managing server to said electric power supplying company for supplying said electric appliance thus rented out with the electric power.

7. An electric appliance renting system according to claim 4, wherein the electric appliances thus rented out has a first information electric appliance which is connected to said rent managing server of said service providing company through a communication network and a second information electric appliance which is connected to said first information electric appliance through a communication line.

8. An electric appliance renting system according to claim 7, wherein said first information electric appliance can display thereon the data relating to the work situation and the consumed electric power rates of said first and second information electric appliances.

9. An electric appliance renting system according to claim 7, wherein said first information electric appliance can carry out the maintenance diagnosis or the replacement diagnosis of said information electric appliance which is connected to said first information electric appliance through said communication line.

10. An electric appliance renting system for renting electric appliances, comprising: at least one electric appliance which is rented out, inclusively of the electric power rate, from a service providing company to a use contractor; and a rent managing server for managing the rented electric appliance(s) which said service providing company has,
wherein said electric appliance has communication means for sending work result data to said rent managing server, and said rent managing server has communication means for receiving the work result data sent from said electric appliance.

11. An electric appliance renting system according to claim 10, wherein said rent managing server includes means for calculating a charge which is to be charged for a use contractor leasing said electric appliance in accordance with the work result data and for calculating the electric power rate which is to be paid to an electric power supplying company in accordance with the work result data.

12. An electric appliance renting system according to claim 10, wherein said rent managing server records and manages thereat the work result data.

13. An electric appliance renting system according to claim 10, further comprising an information terminal through which the rent is carried out inclusively of the electric power rate, and said electric appliance, said information terminal and said rent managing server have communication means for communicating with said information terminal, communication means for communicating with said electric appliance and said rent managing server, and communication means for communicating with said information terminal, respectively, and said information terminal has means for recording the work result data, means for operating arithmetically an amount of consumed electric power from the work result data, and means for sending the data relating to an amount of consumed electric power thus arithmetically operated to said rent managing server.

14. An electric appliance renting system according to claim 11, wherein said electric appliance has operation controlling means for controlling the operation thereof, and said rent managing server has means for obtaining an amount of consumed electric power of said electric appliance on the basis of the control data provided by said operation controlling means and for obtaining the use rate inclusive of an electric power rate which is to be charged for a use contractor and the electric power rate which is to be paid to said electric power supplying company.

15. An electric appliance renting system according to claim 10, further comprising electric power measuring means for measuring the electric power of said electric appliance, wherein said rent managing server has means for operating arithmetically the use charge inclusive of an electric power rate which is to be charged for a use contractor and the electric power rate which is to be paid to said electric power company on the basis of an amount of electric power measured by said electric power measuring means.

16. An electric appliance renting system according to claim 10, wherein said rent managing server can send the data relating to the situation of the half-way progress of use of the electric power to said electric appliance.

17. An electric appliance renting system according to claim 13, wherein said rent managing server can send the data relating to the situation of the half-way progress of use of the electric power to said electric appliance.

18. An electric appliance renting system according to claim 11, wherein said rent managing server carries out the arithmetic operation in such a way that when the operation result data of said electric appliance is equal to or smaller than a predetermined amount, the consumed electric power rate is decided as the fixed amount, while when the operation result data of the electric appliance exceeds the predetermined amount, the consumed electric power rate is increased in accordance with the work result data.

19. An electric appliance renting system according to claim 10, wherein said rent managing server includes judgement means for on the basis of the work result data sent from said electric appliance, carrying out the judgement of abnormality of said electric appliance and for judging on the basis of the judgement result whether or not the maintenance needs to be carried out.

20. An electric appliance renting system according to claim 10, wherein said rent managing server includes means for generating a running pattern on the basis of the work result data sent from said electric appliance to compare the total cost up to the scrapping processing of said electric appliance with the total cost up to the scrapping processing of an electric appliance which is replaceable with said electric appliance to execute the replacement judgement for said electric appliance.
